(19) United States
(12) Patent Application Publication
(10) Pub. No.: US 2006/0174103 A1
(43) Pub. Date: Aug. 3, 2006

(54) System and method for integrating PKI and XML-based security mechanisms in SyncML

(75) Inventors: Sanjeev Verma, San Diego, CA (US); Srinivas Bindignavile, Westford, MA (US); Senthil Sengodan, San Diego, CA (US); Markku Pulkkinen, Oulu (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/227,582

(22) Filed: Sep. 14, 2005

Related U.S. Application Data
(60) Provisional application No. 60/610,405, filed on Sep. 16, 2004.

(51) Int. Cl. H04L 9/00

(52) U.S. Cl. 713/151

(57) ABSTRACT

Additions of extensions to SyncML protocol to incorporate PKI-based and XML-based security mechanisms. The present invention involves the partial incorporation of the PKI based mechanisms present in the Rights Object Acquisition Protocol (ROAP) suite of OMA DRMv2 model into the SyncML protocol, resulting in security enhancements for SyncML.

### FIELD OF THE INVENTION

The present invention relates generally to the synchronization of data and personal information. More particularly, the present invention relates to the use of extensions added to the SyncML protocol to incorporate PKI-based and XML-based security mechanisms.

### BACKGROUND OF THE INVENTION

SyncML is an open industry standard for the synchronization of data and personal information across multiple networks, platforms and devices. Conventional SyncML systems use symmetric security mechanisms to provide security to devices on the respective networks. Such mechanisms possess an advantage in terms of computational speed and simplicity. However, under this arrangement, every device management (DM) server authenticating the respective device needs to store symmetric credentials for the device. Such a system is not very modular in nature. Additionally, the security mechanisms based on symmetric credentials are not scalable. Furthermore, in conventional systems, authentication is performed one entity (device or DM server) at a time, which can encourage an active man-in-the middle (MITM) attack. Additionally, confidentiality protection is optional and is not provided as a part of the protocol.

Unlike the encryption system offered by Secure Sockets Layer (SSL) technology over HyperText Transfer Protocol (HTTP), which only exists for the duration of transit and is not persistent, extensible markup language (XML) Encryption can be used to maintain the confidentiality of the message flow between a management data source, the device management server (DMS) and the terminal, both in transit as well as for storing in encrypted form at the two ends.

Message confidentiality leverages XML Encryption in conjunction with security tokens (as defined in the previous section) to keep portions of the DM message confidential. Encryption of any combination of body blocks, header blocks, and any of these sub-structures is possible by either a common symmetric key shared by the producer and the recipient or a symmetric key carried in the message in an encrypted form. Although a symmetric shared key is used for encryption, the shared key could be a shared session key, which is derived from the public key infrastructure (PKI). Three elements are used with the <syncML:Security> header block. When a producer encrypts portions of a SyncML message using XML Encryption, they must prepend a subelement to the <syncML:Security> header block. The new sub-element can be prepended to an existing or new <syncML:Security> block.

A <xenc:ReferenceList> element may be used to create a manifest of encrypted portion(s), which are expressed as <xenc:EncryptedData> elements within the SyncML message. The encrypted element (or element content) must be replaced by a corresponding <xenc:EncryptedData> according to XML encryption. All of the <xenc:EncryptedData> elements created by this encryption step should be listed in <xenc:DataReference> elements inside one or more <xenc:ReferenceList> element. The <xenc:EncryptedData> elements referenced by the same <xenc:ReferenceList> may be encrypted by different keys. Each encryption key can be specified in <KeyInfo> within an individual <xenc:EncryptedData> element. An example showing the use of XML encryption for a SyncML message is shown below.

```
    <SyncML>
      <syncML:Security>
        <xenc:ReferenceList>
            <xenc:DataReference URI=“#bodyID”/>
        </xenc:ReferenceList>
</syncML:Security>
    <SyncHdr>
        </SyncHdr>
        <SyncBody>
            <xenc:EncryptedData Id=“bodyID”>
                <KeyInfo>
                <KeyName>
                      CN=Hiroshi Maruyama, C=JP
                    </KeyName>
                </KeyInfo>
                <xenc:CipherData>
                    <xenc:CipherValue>...</xenc:CipherValue>
                </xenc:CipherData>
      </xenc:EncryptedData>
      </SyncBody>
    </SyncML>
```

The combination of signing and encrypting over a common data item may introduce some cryptographic vulnerability. For example, encrypting digitally signed data, while leaving the digital signature in the clear, may allow plain text guessing attacks.

When the encryption step involves encrypting elements or element contents within a SyncML message with a symmetric key (session key), which is in turn to be encrypted by the recipient's key and embedded in the message, <xenc:EncryptedKey> may be used for carrying such an encrypted key. A sample listing of the use of <xenc:EncryptedKey> is shown below.

```
    <SyncML>
      <syncML:Security>
        <xenc:EncryptedKey>
                ...
            <KeyInfo>
                        ...
            </KeyInfo>
                ...
        </xenc:EncryptedKey>
                ...
  </syncML:Security>
      <SyncHdr>
      </SyncHdr>
<SyncBody>
        <xenc:EncryptedData Id=“bodyID”>
                <xenc:CipherData>
                    <xenc:CipherValue>...</xenc:CipherValue>
                </xenc:CipherData>
        </xenc:EncryptedData>
</SyncBody>
```

While XML Encryption specifies that <xenc:EncryptedKey> elements may be specified in <xenc:EncryptedData> elements, <xenc:EncryptedKey> elements can be placed in the <syncML:Security> header. This is justified by the fact that relatively static information (such as cryptographic keys) is normally placed in the header rather than the body security tokens.

The <syncML:Security> header is a mechanism for conveying security information with and about a SyncML DM message. This header is, by design, extensible to support many types of security information. For tokens based on XML, this extensibility allows for these security tokens to be directly inserted into the header. The security tokens are to be used in conjunction with XML signature and XML encryption.

The claims, which are conveyed by a security token, might reside elsewhere and would need to be “pulled” by the receiving application. An extensible mechanism for referencing such security tokens is provided by the <syncML:SecurityTokenReference> element. This element provides an open content model for referencing security tokens. It must be used inside the <syncML:Security> header. The <syncML:SecurityTokenReference> element can be used as a direct child element of <KeyInfo> to indicate a hint to retrieve the key information from a security token placed elsewhere. In particular, when using XML Signature and XML Encryption, a <syncML:SecurityTokenReference> element should be placed inside a <KeyInfo> to reference the security token used for the signature or encryption.

The security tokens can be referenced in multiple ways. With direct references, references can include tokens using uniform resource identifier (URI) fragments and external tokens using full URIs. This is achieved by means of the <SyncML:Reference> element which provides an extensible mechanism for directly referencing security tokens using URIs.

```
<syncML:SecurityTokenReference>
    <syncML:Reference
        URI=“http://www.fabrikam123.com/
            tokens/Zoe”/>
</syncML:SecurityTokenReference>
```

Key identifiers allow tokens to be referenced using an opaque value that represents the token. If a direct reference is not used, it is preferable to reference a security token using a key identifier rather than a <KeyName>. This approach can be used to uniquely identify a security token (e.g. a hash of the token). In this case, the <syncML:KeyIdentifier> element is placed inside the <syncML:SecurityTokenReference> element.

Key names allow tokens to be referenced using a string that matches an identity assertion within the security token. Alternatively, an embedded Reference allows tokens to be embedded (as opposed to a pointer to a token that resides elsewhere). In this case, the <syncML: Embedded> element is specified within a <syncML:SecurityTokenReference> element.

### SUMMARY OF THE INVENTION

The present invention involves the addition of extensions to SyncML protocol to incorporate PKI-based and XML-based security mechanisms. The present invention involves the partial incorporation of the PKI based mechanisms present in the Rights Object Acquisition Protocol (ROAP) suite of OMA DRMv2 model into the SyncML protocol.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows the basic structure of an SyncML package as defined by the representation protocol according to one embodiment of the invention;

FIG. 2 is a representation showing the setup phase of a 4-pass registration mechanism in SyncML;

FIG. 3 is a representation of the implementations of a 4-pass registration mechanism in SyncML according to one embodiment of the present invention;

FIG. 4 is a representation showing device-specific information in the DevInfo management object;

FIG. 5 is a representation of the structure of a DM server including PKI specific information under the “DMAcc/x/PKI” node in the SyncML DM management object tree; and

FIG. 6 is a device management state diagram according to one embodiment of the present invention.

### DETAILED DESCRIPTION OF THE PREFERRED EMBODIMENTS

An OMA DRMv2 model deploys PKI-based mechanisms in the 4-pass registration protocol as a part of the ROAP-protocol suite. In using the ROAP 4-pass registration protocol, device and RI (Rights Issuer) server hello messages are used to exchange IDs (Device and RI server IDs), supported algorithms and trusted CAs. A RI server nonce is sent in the RI hello message. The device and the RI server also mutually authenticate each other through registration request/response messages by exchanging signatures on previous messages (such as an XML signature using a private key). The device also sends its nonce in the request message. The execution of the protocol therefore results in the mutual authentication of the device and the RI server and the establishment of a security context between them. The security context contains server and device IDs, algorithms, supported certificates and the security context timeout.

The optional protocol extensions through a peer key identifier and certificate caching allow for the storage of certificates to optimize the message exchanges.

SyncML contains a set of well-defined messages that are conveyed between a client and a server participating in a data synchronization operation. SyncML supports a request-response data synchronization structure, as well as blind push commands. The specification specifies an XML document-type description (DTD) that allows the representation of all information required to perform synchronization, including data, metadata and commands. The synchronization specification specifies the SyncML messages that conform to the DTD in order to allow a SyncML client and server to exchange additions, deletions, updates and other status information.

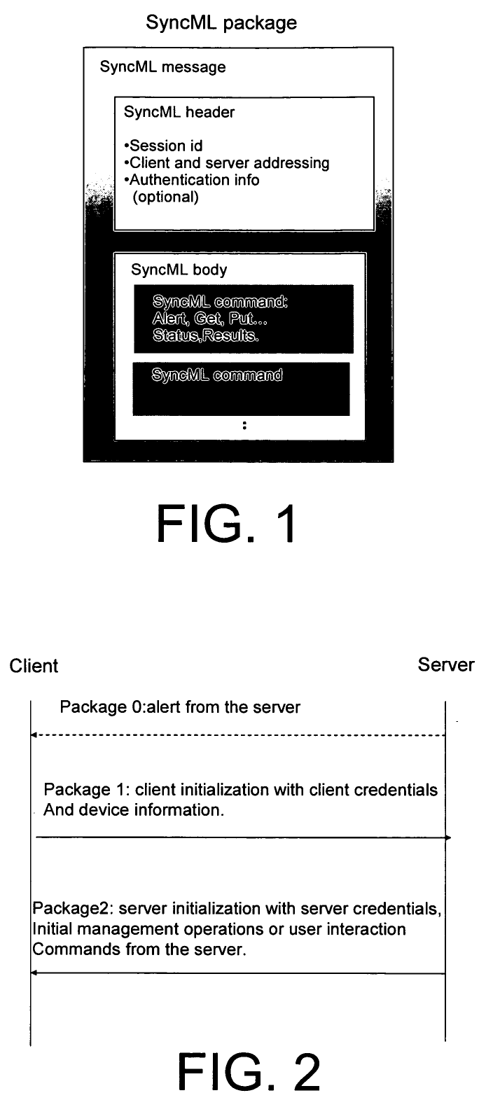

FIG. 1 shows the basic structure of an SyncML package as defined by the representation protocol. The SyncML package may contain more than one SyncML message. The SyncML message is a well-formed XML document that contains an SyncML header that includes version, routing, session, authentication information, as well as a SyncML body that contains the various commands to be performed.

SyncML has two types of commands: Request Commands and Response Commands. Request Commands include: Add, Alert, Atomic, Copy, Delete, Exec, Get, Map, MapItem, Put, Replace, search, sequence, synch. Response Commands include: status and results.

The current implementation of SyncML supports two types of authentication schemes: the “Basic” and “MD5 Digest Access” authentication schemes. An authentication challenge can be specified for or against the SyncML server, database or an individual command on a database.

The present invention involves the integration of PKI and XML security mechanisms into the SyncML protocol. Also, the associated extensions are configured such that peers with new SyncML version are also able to work against with peers with legacy implementations and vice-versa The mechanisms that are implemented during setup phase are:

1. Initial Handshake: The device and the server should be able to make inquiries with each other regarding the support of PKI mechanisms.

2. Exchange of parameters associated with the setting up of PKI security contexts: certificates, nonces, IDs, algorithms, security context timeout.

3. Mutual authentication between the Device and the DM server using XML signatures on the messages exchanged.

Once the PKI security context is established between the device and the DM server, XML security mechanisms can be used for command-level and database level authentication and protection during the management phase. The DM server uses the public key of the client device to send the secret to be used in XML security mechanisms. The secret is a hash (SHA-1) of the secret known to the server only with the device's identity (International Mobile Equipment Identity) and nonces. The use of IMEI in the calculation associates the shared secret with the device. The shared secret is used by the XML security mechanisms to protect messages during the management phase.

Additional information in the form of the sub tree is needed to maintain the PKI security context between the client and the DM server. Since there can be more than one DM server managing the device, there are several such contexts in the device corresponding to each DM server. The 4-pass PKI mechanism creates a PKI security context in the device for a given DM server. The device and the DM server use XML signatures (using private key) over the messages exchanged during SyncML setup phase for mutual authentications.

The Device Management session can be identified by a session ID field in the PKI security context. This allows for several concurrent DM server-device sessions. Once the security context is established between the device and the DM server, secured communications can be achieved using XML-security based mechanisms. The device and the DM server can also store certificate chain information regarding each-other so that they need not send this information in the subsequent messages. The DM server stores a peer key identifier which identifies the device key stored by the DM server. The key identifiers are the same as the device/DM server IDs, which means that they are calculated as SHA-1 hash on the public key information of device/DM server. The purpose of peer key identifier is to inform the peer entity that the communicating entity already has a peer certificate in its local storage. If the peer key identifier matches the current key of the device, then the device need not send the certificate chain in the subsequent message. Similarly, the device stores a peer key identifier for the DM server certificate chain. This minimizes the message size of the subsequent messages (e.g., package 3 and package 4).

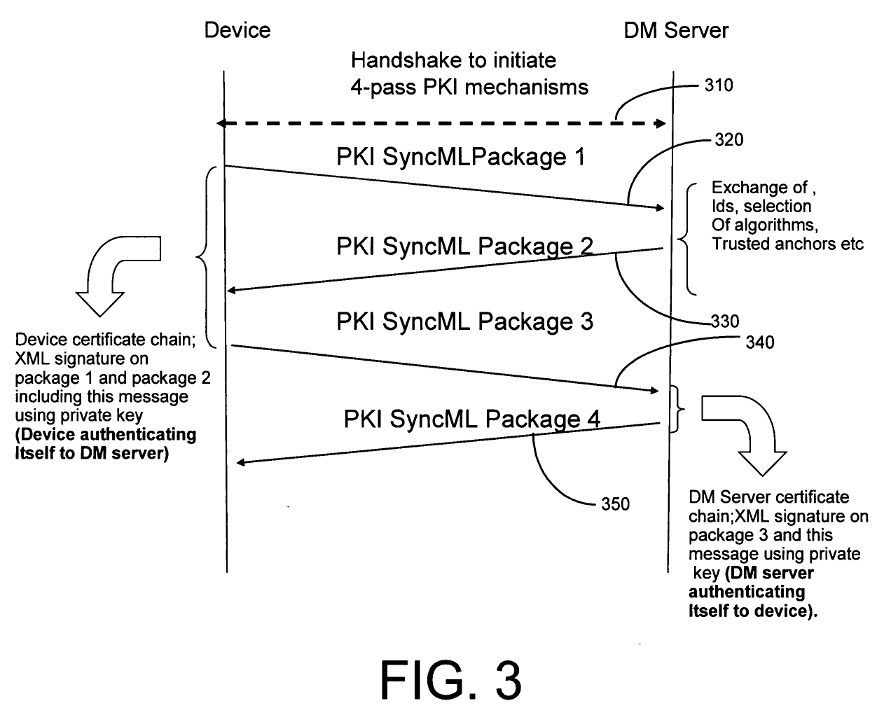

FIG. 3 illustrates the implementations of a 4-pass registration mechanisms (from ROAP suite) in SyncML. 4-pass registration protocol is implemented through SyncML commands. The subset of SyncML commands that can be used to implement 4-pass registration protocol are as follows:

1. Alert: This command is used to communicate content information, such as state information or notifications, to an application in the recipient device. There are a number of undefined Alert codes (211-220) that have been reserved for future usage.

2. Add: This specifies the SyncML command to add data to a data collection.

3. Get: This specifies the SyncML command to retrieve data from the recipient. The data returned from a “Get” command is returned in a “Results” element type in a subsequent SyncML message.

4. Put: This specifies the SyncML command to transfer data items to a recipient network device or database.

5. Replace: This specifies the SyncML command to replace data on the recipient. If the specified data item does not exist, then the command must be interpreted as an “Add” command.

6. Results: This specifies the SyncML command that is used to return the results of the “Get” or “Search” command.

7. Sequence: This specifies the SyncML command to order the processing of a set of SyncML commands.

A system constructed according to the principles of the present invention supports both legacy and improved DM servers with PKI/XML security mechanisms. SyncML DM protocol has two phases: a setup phase and a management phase. The mutual authentication and establishment of PKI security context occurs in the setup phase. Mutual authentication and PKI security context establishment can also be used when legacy authentication methods have been used to manage some general settings and later enhanced PKI-based security mechanisms are needed for certain management commands.

For an initial handshake, represented at 310 in FIG. 3, a trigger is required to initiate the 4-Pass PKI-based mutual authentication mechanisms. This can either be initiated by the client or by the DM server. This mechanism can be used to renew PKI context whenever the PKI security context times out. Two alert messages that use alert codes from the code space (211-220) reserved for future use are listed below in Table 1.

TABLE 1
Alert codes for 4-pass PKI authentication mechanism.

| | | |
|---|---|---|
| 211 | 4-Pass PKI Authentication | Specifies a client-initiated, 4-pass |
| | by client | authentication mechanism. |
| 212 | 4-Pass PKI Authentication | Specifies a server-initiated, 4-pass |
| | by server | authentication mechanism. |

For example, the client can request the 4-Pass PKI authentication mechanism by sending an “Alert” command to the DM server with Alert code 211. If the DM server happens to be the legacy server, then it will return the “Status” command with status code 501, indicating that it does not support the 4-Pass PKI based mechanism. On the other hand, if the DM server supports the PKI mechanism, then it will return the “Status” command with the status code 200.

The DM Server can also request the 4-Pass PKI authentication mechanism by sending an “Alert” command with Alert code 212. The client can return the corresponding “Status” command in the SyncML package 1, which is represented at 320 in FIG. 3.

The code for one exemplary implementation of the initial handshake is as follows.

```
<SyncML xmlns=SYNCML:SYNCML1.1>
  <SyncHdr>
    <VerDTD>1.1</VerDTD>
    <VerProto>DM/1.1</VerProto>
    <Session ID>1</SessionID>
      <Target>
      <LocURI>http://www.nokia.com/dm-server</LocURI>
      </Target>
      <Source>
      <LocURI>IMEI:493005100592800</LocURI>
      </Source>
  </SyncHdr>
  <SyncBody>
    <Alert>
      <CmdID>1</CmdID>
      <Data>211</Data> <!-client initiated 4-pass PKI authentication-->
    </Alert>
  </SyncBody>
</SyncML>
```

The following is an alternate set of code for an initial handshake

```
<SyncML xmlns=SYNCML:SYNCML1.1>
    <SyncHdr>
        <VerDTD>1.1</VerDTD>
        <VerProto>DM/1.1</VerProto>
        <Session ID>1</SessionID>
          <Source>
          <LocURI>http://www.nokia.com/dm-server</LocURI>
          </Source>
          <Target>
          <LocURI>IMEI:493005100592800</LocURI>
          </Target>
    </SyncHdr>
    <SyncBody>
        <Status>
          <MsgRef>1</MsgRef><CmdRef>1</CmdRef>
          <CmdID>1</CmdID>
          <Cmd>Alert</Cmd>
          <Data>200</Data> <!-Successful; will contain code 501 if
          not -->
                        <!-implemented.
        </Status>
    </SyncBody>
</SyncML>
```

PKI SyncML Package 1, represented at 320 in FIG. 3, corresponds to the “Device Hello” message in the 4-pass registration protocol and is sent by the device to the DM server. The device identifies itself to the DM server through a Device ID, which is basically a SHA-1 hash of the Device's public key info, as it appears in the certificate. The device may also identify the cryptographic algorithms (e.g., a hash algorithm or signature algorithm) that are supported by the device. Alternatively, mandatory cryptographic algorithms for the PKI mechanisms can be specified. In such a case, there is no need for the device to inform the DM server regarding supported crypto algorithms. The following mandatory cryptographic algorithms can be used: RSA for authentication, AES for Encryption and SHA-1 for integrity protection. The device may also indicate whether it has the capability of certificate caching. The package will also contain additional device information as described herein.

Exemplary code for the PKI SyncML Package 1 is as follows.

```
<SyncML xmlns=SYNCML:SYNCML1.1>
    <SyncHdr>
        <VerDTD>1.1</VerDTD>
        <VerProto>DM/1.1</VerProto>
        <Session ID>1</SessionID>
          <Target>
          <LocURI>http://www.nokia.com/dm-server</LocURI>
          </Target>
          <Source>
          <LocURI>IMEI:493005100592800</LocURI>
          </Source>
    </SyncHdr>
    <SyncBody>
        <Replace>
          <CmdID>2</CmdID>
            <meta><Type xmlns=’syncml:metinf’>application/vnd.syncml-
            devinf+xml</Type></Meta>
            <Item>
              <Source><LocURI>./DevInfo/Man</LocURI></Source>
              <Meta>
              <Format xmlns=”syncml:metinf”>chr</Format>
              <Type xmlns=”syncml:metinf”>text/plain</Type>
              </Meta>
                    <Data> Nokia Inc.</Data>
                </item>
            <Item>
              <Source><LocURI>./DevInfo/Mod</LocURI></Source>
              <Meta>
              <Format xmlns=”syncml:metinf”>chr</Format>
              <Type xmlns=”syncml:metinf”>text/plain</Type>
              </Meta>
                    <Data> 3650</Data>
                </item>
            <Item>
              <Source><LocURI>./DevInfo/DevID</LocURI></Source>
              <Meta>
              <Format xmlns=”syncml:metinf”>chr</Format>
              <Type xmlns=”syncml:metinf”>text/plain</Type>
              </Meta>
                    <Data> 493005100592800</Data>
                </item>
                <Item>
            <Source><LocURI>./DevInfo/Ext/Hash</LocURI></Source>
              <Meta>
              <Format> xmlns=’syncml:metinf’>chr</Format>
              <Type> xmlns=’syncml:metinf’>text/plain</Type>
              </Meta>
              <Data>SHA-1</Data>
            </item>
                  <Item>
            <Source><LocURI>./DevInfo/Ext/MAC</LocURI></Source>
              <Meta>
                <Format> xmlns=’syncml:metinf’>chr</Format>
                Type> xmlns=’syncml:metinf’>text/plain</Type>
              </Meta>
              <Data>HMAC-SHA-1</Data>
            </item>
                  <Item>
            Source><LocURI>./DevInfo/Ext/Auth</LocURI></Source>
              <Meta>
                <Format> xmlns=’syncml:metinf>chr</Format>
                <Type> xmlns=’syncml:metinf’>text/plain</Type>
              </Meta>
              <Data>RSA</Data>
            </item>
                  <Item>
            Source><LocURI>./DevInfo/Ext/Encrypt</LocURI></Source>
              <Meta>
                <Format> xmlns=’syncml:metinf’>chr</Format>
                <Type> xmlns=’syncml:metinf’>text/plain</Type>
              </Meta>
              <Data>AES128</Data>
            </item>
            .
        </Replace>
        </Final>
    </SyncBody>
</SyncML>
```

PKI SyncML Package 2, represented at 330 in FIG. 3 corresponds to the “RI Hello” message in the 4-pass registration protocol and is sent from DM server to the device. The DM server identifies itself to the device through a DM ID, which is basically SHA-1 hash of the DM server's public key info, as it appears in its certificate. It also contains the DM server nonce that is a randomly generated number and must not be reused. The package can also contain a “Peer Key Identifier” for a device key stored by the DM server. If the identifier matches the device's current key, then it implies that device needs not send its certificate chain in Package 3, which is represented at 340 in FIG. 3. The DM server may further indicate whether it has the capability of certificate caching. This package will also contain additional device information as discussed herein.

Exemplary code for the PKI SyncML Package 2 is as follows.

```
<SyncML xmlns=SYNCML:SYNCML1.1>
    <SyncHdr>
        <VerDTD>1.1</VerDTD>
        <VerProto>DM/1.1</VerProto>
        <Session ID>1</SessionID>
        <Source>
        <LocURI>http://www.nokia.com/dm-server</LocURI>
          </Source>
          <Target>
        <LocURI>IMEI:493005100592800</LocURI>
          </Target>
    </SyncHdr>
    <SyncBody>
        <Replace>
          <CmdID>2</CmdID>
          <Item>
          <Source><LocURI>./SyncML/DMAcc/x*/PKI/
          ServerID</LocURI>
            </Source>
          <Meta>
            <Format> xmlns=’syncml:metinf’>chr</Format>
            <Type> xmlns=’syncml:metinf’>text/plain</Type>
          </Meta>
          <Data>74587465826588743</Data>
                </item>
              <Item>
        <Source><LocURI>./SyncML/DMAcc/x*/PKI/
        ServerNonce</LocURI>
              </Source>
          <Meta>
            <Format> xmlns=’syncml:metinf’>chr</Format>
            <Type> xmlns=’syncml:metinf’>text/plain</Type>
          </Meta>
          <Data>hk678it9b8</Data>
        </item>
              <Item>
              <Source><LocURI>./SyncML/DMAcc/x*/
              PKI/ Server PeerKey ID</LocURI></Source>
          <Meta>
            <Format> xmlns=’syncml:metinf’>chr</Format>
            <Type> xmlns=’syncml:metinf’>text/plain</Type>
          </Meta>
          <Data>493005100592800</Data>
                </item>
<item>
        </Replace>
        </Final>
    </SyncBody>
</SyncML>
```

PKI SyncML Package 3, represented at 340 in FIG. 3, corresponds to the “Registration Request” message in the 4-pass registration protocol and is sent by the device to the DM server. This message contains a randomly generated device nonce that must not be reused. It must also contain a device certificate chain unless the preceding Package 2 contains the “Peer Key Identifier” and its value is identified the key in the device's current certificate. This message can also contain a “Peer Key Identifier” which identifies the DM server certificate stored in the device. Furthermore, the device also authenticates itself to the DM server by including a XML signature using its private key on a hash of the two previous packages (Package 1 and Package 2) and all the parameters of this package excluding the signature.

Exemplary code for the PKI SyncML Package 3 is as follows.

```
<SyncML xmlns=SYNCML: SYNCML1.1>
    <SyncHdr>
        <VerDTD>1.1</VerDTD>
        <VerProto>DM/1.1</VerProto>
        <Session ID>1</SessionID>
        <Target>
        <LocURI>http://www.nokia.com/dm-server</LocURI>
          </Target>
          <Source>
        <LocURI>IMEI: 493005100592800</LocURI>
          </Source>
          <syncML:Security>
            <ds:Signature>
                <ds:SignedInfo>
                    <ds: CanonicalizationMethod
                            Algorithm= “http://
                            www.w3.org/2001/10/
                                    xml-exc-c14n#”/>
                    <ds:SignatureMethod Algorithm=
                            “http://www.w3.org/2000/09/
                                xmldsig#hmac-sha1”/>
                        <ds:Reference URI=“#MsgBody”>
                            <ds:DigestMethod Algorithm=
                            “http://
                            www.w3.org/2000/09/xmldsig#sha1”/
                            >
                                <ds:DigestValue>
                                    LyLsF0Pi4wPU...
                                </ds:DigestValue>
                        </ds:Reference>
                </ds:SignedInfo>
                    <ds:SignatureValue>
                      DJbchm5gK...
                    </ds:SignatureValue>
                    <ds:KeyInfo>
                        <syncML:SecurityTokenReference>
                          <syncML:Reference URI=“#MyID”/>
                        </syncML:SecurityTokenReference>
                    </ds:KeyInfo>
            </ds:Signature>
        </syncML:Security>
    </SyncHdr>
    <SyncBody>
        <Replace>
        <CmdID>2</CmdID>
        <Item>
        <Source><LocURI>./DevInfo/Ext/x/ClientNonce</
        LocURI></Source>
          <Meta>
            <Format> xmlns=’syncml:metinf’>chr</Format>
            <Type> xmlns=’syncml:metinf’>text/plain</Type>
          </Meta>
          <Data>gh87k7f8h2</Data>
        </item>
        <Item>
        <Source><LocURI>./DevInfo/Ext/DevCert</LocURI></Source>
          <Meta>
            <Format> xmlns=’syncml:metinf’>chr</Format>
            <Type> xmlns=’syncml:metinf’>text/plain</Type>
          </Meta>
          <Data>mQGiBD8BD84JKL34naK...</Data>
        </item>
        <Item>
              <Source><LocURI>./SyncML/DMAcc/x*/PKI/
              Client PeerKey ID</LocURI></Source>
          <Meta>
            <Format> xmlns=’syncml:metinf’>chr</Format>
            <Type> xmlns=’syncml:metinf’>text/plain</Type>
          </Meta>
          <Data>74587465826588743</Data>
          </item>
        </Replace
        </Final>
    </SyncBody>
</SyncML>
```

PKI SyncML Package 4, represented at 350 in FIG. 3, corresponds to the “Registration Response” message in the 4-pass registration protocol and is sent by the DM server to the device. This must also contain DM server certificate chain unless the preceding Package 3 contained the “Peer Key Identifier” and its value identified the key in the DM server's current certificate. This package also contains the shared secret (encrypted using public key of the device) to be used in the subsequent management and synchronization sessions using XML sec. The shared secret is a hash of the secret known to the DM server, International Mobile Equipment Identity number (IMEI) and nonces (Both the DM server and Device nonce). This shared secret is different every time the 4-pass authentication mechanism is executed since it depends on the nonces that are generated using random number generator. Hence, this mechanism protects against replay attack. The DM server authenticates itself to the device by including a XML signature using its private key on a hash of the previous package (Package 3) and all the parameters of this package excluding the signature.

Exemplary code for the PKI SyncML Package 4 is as follows.

```
<SyncML xmlns=SYNCML: SYNCML1.1>
  <SyncHdr>
    <VerDTD>1.1</VerDTD>
    <VerProto>DM/1.1</VerProto>
    <Session ID>1</SessionID>
    <Source>
    <LocURI>http://www.nokia.com/dm-server</LocURI>
    </Source>
    <Target>
    <LocURI>IMEI:493005100592800</LocURI>
    </Target>
      <syncML:Security>
    <xenc:ReferenceList>
              <xenc:DataReference URI=“#bodyID”/>
          </xenc:ReferenceList>
        <xenc:EncryptedKey>
          ...
          <ds:KeyInfo>
            ...
          </ds:KeyInfo>
            ...
        </xenc:EncryptedKey>
          ...
      </syncML:Security>
  </SyncHdr>
  <SyncBody>
    <xenc:EncryptedData Id=“bodyID”>
        <xenc:CipherData>
            <xenc:CipherValue>...</xenc:CipherValue>
    </xenc:CipherData>
    </xenc:EncryptedData>
      <Replace>
      <CmdID>3</CmdID>
      <Item>
      <Source><LocURI>./SyncML/DMAcc/x*/PKI/
      ServerCert</LocURI>
            </Source>
        <Meta>
          <Format> xmlns=’syncml:metinf’>chr</Format>
          <Type> xmlns=’syncml:metinf’>text/plain</Type>
        </Meta>
        <Data>gh87k7f8h2hdgh9u8ty......</Data>
      </item>
      <Item>
      <Source><LocURI>./SyncML/DMAcc/x*/PKI/
      SharedSecret</LocURI>
            </Source>
        <Meta>
          <Format> xmlns=’syncml:metinf’>chr</Format>
          <Type> xmlns=’syncml:metinf’>text/plain</Type>
        </Meta>
        <Data>gh87k7f8h2jgfdskjg</Data>
      </item>
      </Replace>
    </Final>
  </SyncBody>
</SyncML>
```

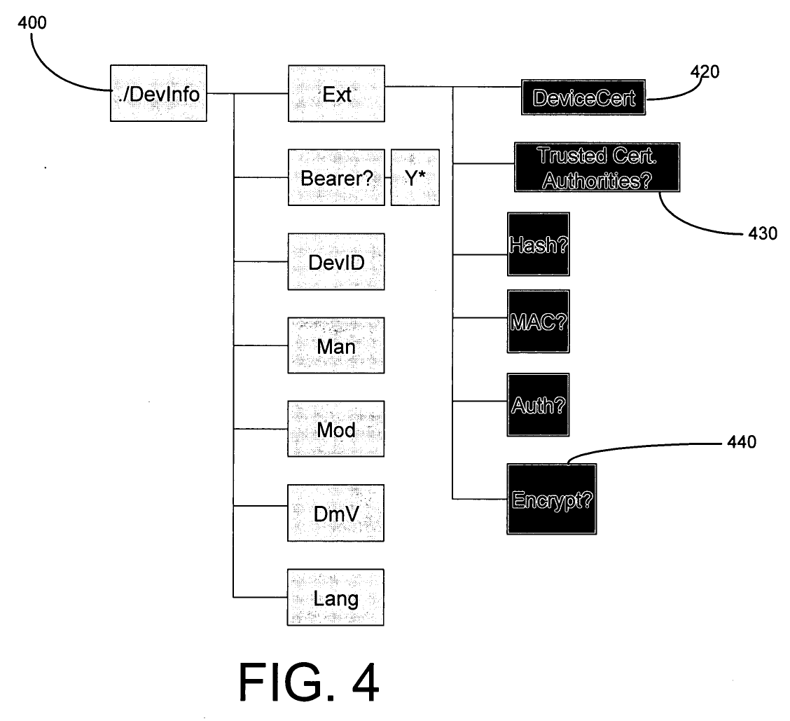

In one embodiment of the invention, both the device and the DM server maintain PKI security information. The device maintains device specific information in the DevInfo management object, as is represented in FIG. 4. This information is sent by the device to the DM server at the beginning of the management session (in SyncML Package 1). The following items maybe included in the DevInfo management object 440 to support the PKI mechanism.
1. Supported crypto algorithms 410 (Optional)
2. Device certificate chain 420
3. Trusted Certification Authorities 430 (Optional).r

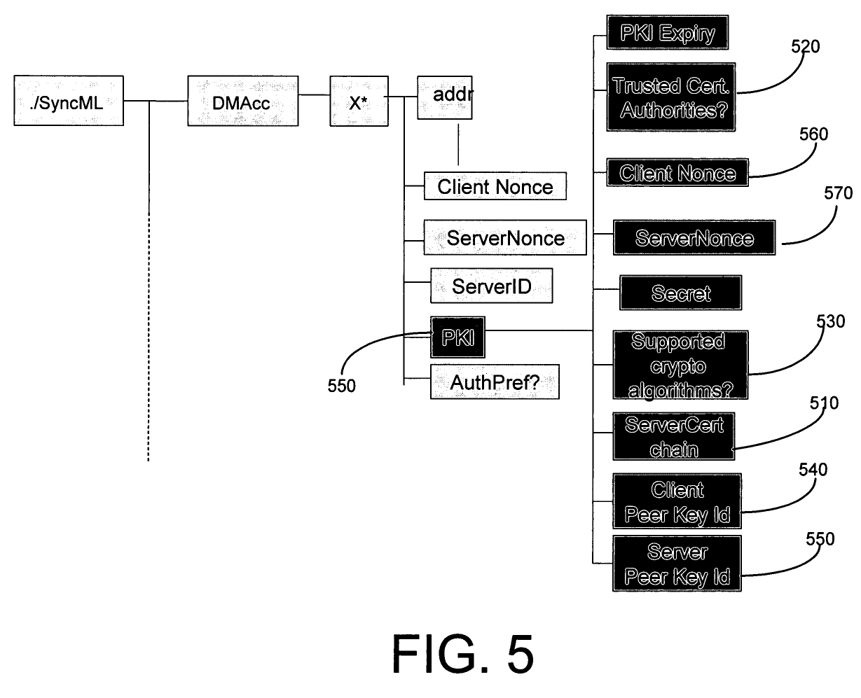

Similarly the DM server can also maintain additional PKI specific information under the “DMAcc/x/PKI” node 500 in the SyncML DM management object tree represented in FIG. 5.:

1. DM server certificate chain 510
2. Trusted Certification Authorities 520 (Optional)
3. Supported crypto algorithms 530 (Optional)
4. Server Peer key identifier 540—for the device key stored by the DM Server.
5. Device Peer Key Identifier 550—for the server key stored by the Device.
6. Nonces (both device 560 and Server 570); PKI expiry time; shared secret;

SyncML DM messages can be authenticated using the XML signature as described for the packages in earlier sections. Furthermore, for protecting the confidentiality of SyncML DM messages between a terminal and a DM Server, XML encryption can be used for command and database content level encryption.

The present invention allows for the encryption of any combination of body blocks, header blocks, and any of these sub-structures by either a common symmetric key shared by the producer and the recipient or a symmetric key carried in the message in an encrypted form. Classical symmetric shared keying could be used for encryption. Alternatively, the shared key could be a shared session key, which is derived dynamically from the PKI. In other words the shared key could be securely communicated to the receiver. This is achieved by encrypting the session key with the receiver's public key, which could then be decrypted with its private key.

Rather than using SSL over HTTP (commonly referred to as HTTPS), XML Encryption is recommended for use in protecting the confidentiality of the SyncML DM messages. When using HTTPS, the entire message gets encrypted; the whole message is then decrypted at the first destination and is open for snooping before it is encrypted again as a whole for the second hop. On the other hand, XML Encryption affords end-to-end security.

Three elements are used with the <syncML:Security> header block. The three elements are <xenc:ReferenceList>, <xenc:EncryptedData> and <xenc :EncryptedKey>.

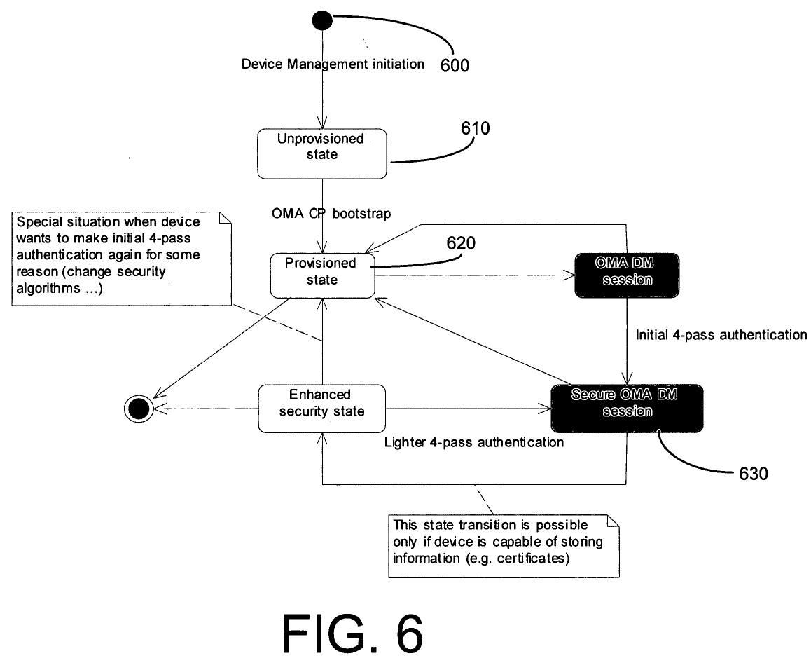

FIG. 6 is a device management state diagram according to one embodiment of the present invention. In an unprovisioned state 610, there is no security context. In a provisioned state 620, the device is provisioned after OMA continuous provisioning bootstrap. In a secure session, the PKI security context is established through the 4-pass authentication mechanism. There is a timeout established with the PKI security context. The device goes back into the provisioned state when the secure session times out. It should be noted that the security context may last several sessions, and both the device and the server decide when the security context should be renewed. Database and command level security is achieved through XML-based security mechanisms. In the enhanced security state, the management session ends. However, the device stores the DM server certificate. A lighter 4-pass authentication (with no need to exchange certificates) mechanism is used to establish a secure management session 630.

While several embodiments have been shown and described herein, it should be understood that changes and modifications can be made to the invention without departing from the invention in its broader aspects. For example, but without limitation, the present invention could be incorporated into a wide variety of electronic devices, such as cellular telephones, personal digital assistants, and other devices. Various features of the invention are defined in the following Claims.

What is claimed is:

1. A method of providing a registration mechanism between a device and a server, comprising the steps of:
providing an initial handshake between the device and the server;
transmitting a “device hello” message from the device to the server;
transmitting an “RI hello” message from the server to the device in response to the “device hello” message;
in response to the “RI hello” message, transmitting a registration request from the device to the server; and
in response to the registration request, transmitting a registration response from the server to the device.

2. The method of claim 1, wherein the “device hello” message includes an identification of the device from the device's certificate.

3. The method of claim 1, wherein the “device hello” message includes a cryptographic algorithm selected from the group consisting of an authentication algorithm, an encryption algorithm and an integrity protection algorithm.

4. The method of claim 1, wherein the “server hello” message includes an identification of the device from the server's certificate.

5. The method of claim 1, wherein the “server hello” message includes a peer key identifier for a device key stored by the server.

6. The method of claim 1, wherein the “server hello” message includes information concerning whether the server is capable of certificate caching.

7. The method of claim 1, wherein the registration request includes a nonreusable, randomly generated device nonce.

8. The method of claim 1, wherein, if the “server hello” message does not contain a peer key identifier of the device including a value identified in the device's current certificate, then the registration request includes a device certificate chain.

9. The method of claim 1, wherein the registration request includes a peer key identifier for the server, the server peer key identifier identifying a certificate for the server that is stored within the device.

10. The method of claim 1, wherein the registration request includes an XML signature using the device's private key.

11. The method of claim 1, wherein, if the registration request does not include a peer key identifier of the server including a value identified in the server's current certificate, then the registration response includes a server certificate chain.

12. The method of claim 1, wherein the registration response includes a shared secret encrypted using a public key of the device.

13. The method of claim 1, wherein the “device hello” message includes device-specific information in a DevInfo management object.

14. The method of claim 13, wherein the device-specific information includes at least one of supported cryptographic algorithms, a device certificate chain, and trusted certification authorities.

15. The method of claim 1, wherein the “server hello” message includes server-specific information.

16. The method of claim 15, wherein the server-specific information includes at least one of a server certificate chain, trusted certification authorities, supported cypotographic algorithms, a server peer key identifier, a device peer key identifier, nonces, PKI expiry time, and a shared secret.

17. A computer program product for providing a registration mechanism between a device and a server, comprising:
computer code for providing an initial handshake between the device and the server;
computer code for transmitting a “device hello” message from the device to the server;
computer code for transmitting an “RI hello” message from the server to the device in response to the “device hello” message;
computer code for, in response to the “RI hello” message, transmitting a registration request from the device to the server; and
computer code for, in response to the registration request, transmitting a registration response from the server to the device.

18. The computer program product of claim 17, wherein the “device hello” message includes an identification of the device from the device's certificate.

19. The computer program product of claim 17, wherein the “device hello” message includes a cryptographic algorithm selected from the group consisting of an authentication algorithm, an encryption algorithm and an integrity protection algorithm.

20. The computer program product of claim 17, wherein the “server hello” message includes an identification of the device from the server's certificate.

21. The computer program product of claim 17, wherein the “server hello” message includes a peer key identifier for a device key stored by the server.

22. The computer program product of claim 17, wherein the “server hello” message includes information concerning whether the server is capable of certificate caching.

23. The computer program product of claim 17, wherein the registration request includes a nonreusable, randomly generated device nonce.

24. The computer program product of claim 17, wherein, if the “server hello” message does not contain a peer key identifier of the device including a value identified in the device's current certificate, then the registration request includes a device certificate chain.

25. The computer program product of claim 17, wherein the registration request includes a peer key identifier for the server, the server peer key identifier identifying a certificate for the server that is stored within the device.

26. The computer program product of claim 17, wherein the registration request includes an XML signature using the device's private key.

27. The computer program product of claim 17, wherein, if the registration request does not include a peer key identifier of the server including a value identified in the server's current certificate, then the registration response includes a server certificate chain.

28. The computer program product of claim 17, wherein the registration response includes a shared secret encrypted using a public key of the device.

29. The computer program product of claim 17, wherein the “device hello” message includes device-specific information in a DevInfo management object.

30. The computer program product of claim 29, wherein the device-specific information includes at least one of supported cryptographic algorithms, a device certificate chain, and trusted certification authorities.

31. The computer program product of claim 17, wherein the “server hello” message includes server-specific information.

32. The computer program product of claim 31, wherein the server-specific information includes at least one of a server certificate chain, trusted certification authorities, supported cypotographic algorithms, a server peer key identifier, a device peer key identifier, nonces, PKI expiry time, and a shared secret.

33. A system for providing a registration mechanism between a device and a server, comprising:
an electronic device; and
a device management server; wherein the electronic device and device management server combine to include a computer program product comprising:
computer code for providing an initial handshake between the electronic device and the device management server;
computer code for transmitting a “device hello” message from the electronic device to the device management server;
computer code for transmitting an “RI hello” message from the device management server to the electronic device in response to the “device hello” message;
computer code for, in response to the “RI hello” message, transmitting a registration request from the electronic device to the device management server; and
computer code for, in response to the registration request, transmitting a registration response from the device management server to the electronic device.

34. The system of claim 33, wherein the “device hello” message includes an identification of the electronic device from the electronic device's certificate.

35. The system of claim 33, wherein the “device hello” message includes a cryptographic algorithm selected from the group consisting of an authentication algorithm, an encryption algorithm and an integrity protection algorithm.

36. The system of claim 33, wherein the “server hello” message includes an identification of the electronic device from the device management server's certificate.

37. The system of claim 33, wherein the “server hello” message includes a peer key identifier for a device key stored by the device management server.

38. The system of claim 33, wherein the “server hello” message includes information concerning whether the device management server is capable of certificate caching.

39. The system of claim 33, wherein the registration request includes a nonreusable, randomly generated device nonce.

40. The system of claim 33, wherein, if the “server hello” message does not contain a peer key identifier of the device including a value identified in the device's current certificate, then the registration request includes a device certificate chain.

41. The system of claim 33, wherein the registration request includes a peer key identifier for the device management server, the peer key identifier identifying a certificate for the device management server that is stored within the device.

42. The system of claim 33, wherein the registration request includes an XML signature using the electronic device's private key.

43. The system of claim 33, wherein, if the registration request does not include a peer key identifier of the device management server including a value identified in the device management server's current certificate, then the registration response includes a server certificate chain.

44. The system of claim 33, wherein the registration response includes a shared secret encrypted using a public key of the electronic device.

45. The system of claim 33, wherein the “device hello” message includes device-specific information in a DevInfo management object.

46. The system of claim 45, wherein the device-specific information includes at least one of supported cryptographic algorithms, a device certificate chain, and trusted certification authorities.

47. The system of claim 33, wherein the “server hello” message includes server-specific information.

48. The system of claim 47, wherein the server-specific information includes at least one of a server certificate chain, trusted certification authorities, supported cypotographic algorithms, a server peer key identifier, a device peer key identifier, nonces, PKI expiry time, and a shared secret
